(19) United States
(12) Patent Application Publication
(10) Pub. No.: US 2017/0223563 A1
(43) Pub. Date: Aug. 3, 2017

(54) DYNAMIC CCA SCHEME WITH INTERFACE CONTROL FOR 802.11 HEW STANDARD AND SYSTEM

(71) Applicant: INTEL CORPORATION, Santa Clara, CA (US)

(72) Inventors: Rongzhen YANG, Shanghai (CN); Po-Kai HUANG, Santa Clara, CA (US); Hujun YIN, Saratoga, CA (US); Robert STACEY, Portland, OR (US); Xiaogang CHEN, Beijing (CN)

(21) Appl. No.: 15/501,298

(22) PCT Filed: Sep. 12, 2014
(86) PCT No.: PCT/CN2014/086427

§ 371 Date: Feb. 2, 2017

(51) Int. Cl. H04W 24/08; H04W 72/08; H04W 74/08; H04L 5/00

(52) U.S. Cl. CPC H04W 24/08; H04L 5/0048; H04L 5/006; H04W 72/082; H04W 72/085; H04W 74/0808; H04W 84/12

(57) ABSTRACT

An interference-control based dynamic CCA scheme is described which will work in any compatible wireless system, including the 802.11 standards mentioned herein and in particular 802.11ac and 802.11ax. The interference control based dynamic CCA scheme can, for example, greatly improve overall wireless LAN system performance compared to other methods. The new scheme is based on interference control, by considering the possible interference to neighbouring devices, and improving overall system performance and inter-device “fairness” through this interference-based consideration technique.

### TECHNICAL FIELD

An exemplary aspect is directed toward communications systems. More specifically an exemplary aspect is directed toward wireless communications systems and even more specifically to CCA in wireless communications systems.

### BACKGROUND

Wireless networks are ubiquitous and are commonplace indoors and becoming more frequently installed outdoors. Wireless networks transmit and receive information utilizing varying techniques. For example, but not by way of limitation, two common and widely adopted techniques used for communication are those that adhere to the Institute for Electronic and Electrical Engineers (IEEE) 802.11 standards such as the 802.11n standard and the IEEE 802.11ac standard.

The 802.11 standard specifies a common Medium Access Control (MAC) Layer which provides a variety of functions that support the operation of 802.11-based wireless LANs (WLANs). The MAC Layer manages and maintains communications between 802.11 stations (such as between radio network cards (MC) in a PC or other wireless devises or stations (STA) and access points (APs)) by coordinating access to a shared radio channel and utilizing protocols that enhance communications over a wireless medium.

802.11n was introduced in 2009 and improved the maximum single-channel data rate from 54 Mbps of 802.11g to over 100 Mbps. 802.11n also introduced MIMO (multiple input/multiple output or spatial streaming), where, according to the standard, up to 4 separate physical transmit and receive antennas carry independent data that is aggregated in a modulation/demodulation process in the transceiver. (Also known as SU-MIMO (single-user multiple input/multiple output.))

The IEEE 802.11ac specification operates in the 5 GHz band and adds channel bandwidths of 80 MHz and 160 MHz with both contiguous and non-contiguous 160 MHz channels for flexible channel assignment. 802.11ac also adds higher order modulation in the form of 256 quadrature amplitude modulation (QAM), providing a 33-percent improvement in throughput over 802.11n technologies. A further doubling of the data rate in 802.11ac is achieved by increasing the maximum number of spatial streams to eight.

IEEE 802.11ac further supports multiple concurrent downlink transmissions (“multi-user multiple-input, multiple-output” (MU-MIMO)), which allows transmission to multiple spatial streams to multiple clients simultaneously. By using smart antenna technology, MU-MIMO enables more efficient spectrum use, higher system capacity and reduced latency by supporting up to four simultaneous user transmissions. This is particularly useful for devices with a limited number of antennas or antenna space, such as smartphones, tablets, small wireless devices, and the like. 802.11ac streamlines the existing transmit beamforming mechanisms which significantly improves coverage, reliability and data rate performance.

IEEE 802.11ax is the successor to 802.11ac and is proposed to increase the efficiency of WLAN networks, especially in high density areas like public hotspots and other dense traffic areas. 802.11ax will also use orthogonal frequency-division multiple access (OFDMA). Related to 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

Carrier Sense (CS) is a fundamental part of wireless networks, and in particular Wi-Fi networks. Since Wi-Fi communicates information over a shared medium, random access to the medium is available to all stations within the network. As such, carrier sense and medium contention are fundamental to network operation and efficiency in order to avoid collisions and interference.

Wi-Fi carrier sense includes two steps—clear channel assessment (CCA) and network allocation vector (NAV). In general CCA is a physical carrier sense which measures received energy in the radio spectrum. NAV is a virtual carrier sense which is generally used by wireless stations to reserve certain portions of the medium for mandatory transmission that would occur after a first transmission. In general, CCA assessment is for determining whether the medium is busy for a current frame and NAV is utilized to determine whether the medium will be busy for future frames.

CCA is defined by IEEE 802.11-2007 and includes two interrelated functions—carrier sense (CS) and energy detection (ED). Carrier sense is functionality performed by the receiver to detect and decode an incoming Wi-Fi preamble signal. The CCA is indicated as busy when another Wi-Fi preamble signal is detected, and held in the busy state based on information in the length field of the preamble.

Energy detection (ED) occurs when a receiver detects a non-Wi-Fi energy level present on a channel (within a frequency range) based on a noise floor, ambient energy, interference sources, an unidentifiable Wi-Fi transmissions that, for example, cannot be decoded, or the like. ED samples the medium every time slot to determine whether energy is present and, based on a threshold, reports as to whether it is believed that the medium is busy.

In addition to the CCA identifying whether the medium is idle or busy for a current frame and noise, the NAV, as discussed, allows stations to indicate an amount of time required for transmission of mandatory frames following transmission of a current frame. NAV is a critical component of Wi-Fi to ensure the medium is reserved for frames that are essential to the operation of the 802.11 protocol. As discussed in the 802.11 standard, NAV is carried in the 802.11 MAC header duration field and encoded at a variable data rate. The station that receives the NAV header duration field can use this information to wait the specified period until the medium is free.

In accordance with one exemplary embodiment, an interference-control based dynamic CCA scheme is proposed which will work in any compatible wireless system, including the 802.11 standards mentioned herein and in particular 802.11ac and 802.11ax. The interference control based dynamic CCA scheme can, for example, greatly improve overall wireless LAN system performance compared to other methods. More specifically, in an 802.11HEW environment, compared to a complex protection mechanism for spatial reuse, the non-zone based methods for CCA adjustment can enjoy simplicity in real-world implementations.

As background, one proposed Dynamical Sensitive Control (DSC) scheme that showed huge gain in mean throughput damaged user throughput by 5% due to lack of interference control. Another proposed scenario was evaluated and showed greater than 4 times performance improvement, however this method lacked interference control and mitigation, and resulted in significant performance loss due to poor link conditions.

In accordance with one exemplary aspect, a new scheme is proposed based on interference control, by considering the possible interference to neighbouring device(s), and improving overall system performance and inter-device “fairness” through this interference-based consideration technique.

In the following detailed description, numerous specific details are set forth in order to provide a thorough understanding of the disclosed techniques. However, it will be understood by those skilled in the art that the present invention may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

Before undertaking the description of embodiments below, it may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary communications environment;

FIG. 2 illustrates an exemplary communications device;

FIG. 3 illustrates an exemplary test environment; and

FIG. 4 is a flowchart illustrating an exemplary CCA technique.

### DESCRIPTION OF EMBODIMENTS

The exemplary embodiments of this invention will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

Presented herein below are comparisons to known solutions illustrating the new approach showed significant performance gains (e.g., over 30% on access point connected stations and over 300% for D2D stations).

For the comparisons, dynamic sensitivity control (DSC) by Graham Smith, which can be found at: https://mentor.ieee.org/802.11/dcn/13/11-13-1290-00-0hew-dynamic-sensitivity-control-for-hew.pptx—Dynamic Sensitivity Control for HEW SG—IEEE 802.11-13/1290r0, was used.

DSC by Graham Smith was selected as a comparison target because it is a typical dynamic CCA method. The key concepts behind dynamic sensitivity control include:
STA (station) measures the RSSI (Received Signal Strength Indicator) of the AP (Access Point) Beacon (R dBm) and then sets the CCA threshold as:

(R−M)dBm
where, M is the “Margin.” For example:
STA receives a Beacon at −50 dBm, with Margin=20 dB, then the CCA threshold is set as:

(R−M)=−50−20=−70 dBm.

In addition, there is an upper limit to be applied for the beacon RSSI, such as −30 or −40 dBm.

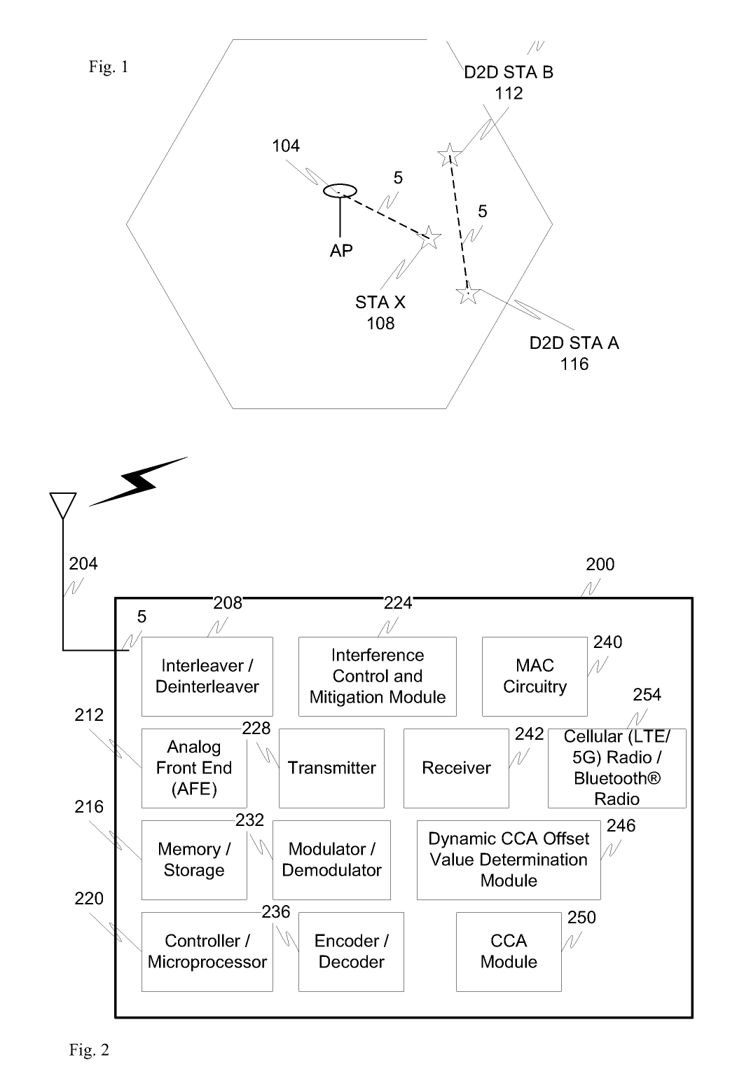

One drawback with this approach is that only the access point signal that is received is considered (similar to pathloss), without considering the interference to others (stations/APs). For this scenario, there are many situations where this is not sufficient and results in a performance loss, with one of these situations being discussed in relation to FIG. 1.

More specifically, FIG. 1 illustrates an access point 104 and a plurality of stations 108-116 in a communications environment 100. In this scenario, station X 108 has a communication link 5 with access point 104, and direct-2-direct (D2D) station B 112 has a communication link 5 with D2D station A 116. As shown in FIG. 1, by executing the DSC algorithm above, a loose threshold is set by the DSC for station X and the D2D station 112 and 116, but they generate very strong interference relative to each other. The same issue can be found in other CCA adjustments schemes where interference to other stations and/or access points is not considered.

An exemplary technique that addresses this problem takes into account the interference to other stations/APs and/or or Wi-Fi devices, by factoring the interference into a CCA threshold calculation which allows the exemplary performance gains as shown below to be realized.

By way of background, in the paper by Graham Smith identified above, there is detailed theory derived that proves the close relationship between downlink received reference signals and uplink interference to other devices in similar transmissions. Mapped to a Wi-Fi system, there is a close relationship between CCA threshold (interference received from others) and interference to others (many “victim” stations). The “victim” stations in the system are distributed in the system with different signals strengths of received packets. The Graham Smith article proves the optimum solution for this kind of question through targeting the maximum system spectral efficiency. The theory discussed in Graham Smith's paper was proved by evaluation results in 802.16m contributions and finally adopted in the 802.16m Standard. In both internal and external evaluation results for ITU-R 4G recommendations, the method adopted in 802.16m provided over 20% gain versus the best LTE power control results in averaged system spectral efficiency, and over 100% gain in cell edge (5%) spectral efficiency.

An exemplary aspect discussed herein is at least applicable to Wi-Fi systems with CCA, and in situations where there is no power control, comparison to prior techniques as shown herein shows over 35% to over 377% performance gain compared to the best known competing solutions.

In accordance with one aspect, the CCA threshold of a station/AP can be adjusted based on the potential interference the station may cause to a neighboring “victim” station, and the signal strength of a packet received at the victim station from the transmitter of the victim station. While, in some cases, there is not one victim station, but many victim stations, the techniques disclosed herein can be modified to account for the fact that the received signal strengths of the packets are distributed values with different probabilities rather than only one deterministic value.

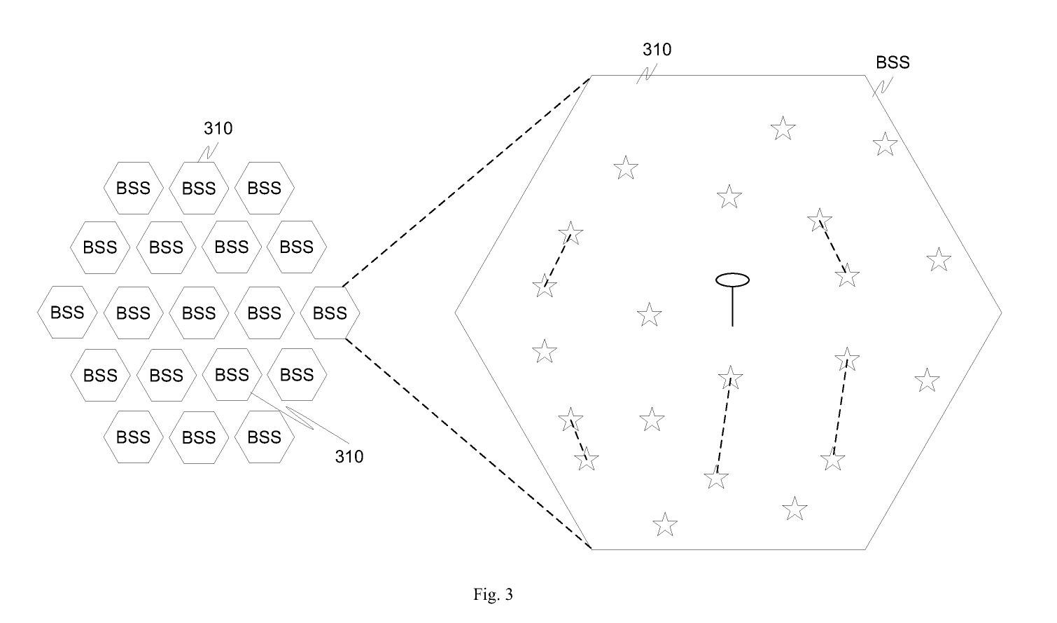

An evaluation scenario was arbitrarily selected from the IEEE 802.11ax evaluation documentation as illustrated in FIG. 3 to test the techniques proposed herein. In the scenario 3 environment, evaluation was performed on an indoor small BSS (Basic Service Set) hotspot. As for the topology in FIG. 3, there are dense small BSS's 310 that are uniform, with approximately 10-20 meters inter-AP distance with approximately hundreds of stations/APs, and P2P pairs. Scenario 3 is a managed environment with an indoor channel model, flat homogeneity, and both enterprise and mobile traffic modelling.

In Scenario 3 in the 802.11ax planning meetings, this indoor small BSS Hotspot (dense) scenario has the objective to capture the issues and be representative of real-world deployments with a high density of APs and STAs. In such environments, the infrastructure network (ESS) is planned. For simulation complexity simplifications, a hexagonal cell layout is considered with a frequency reuse pattern. This frequency reuse pattern is defined and fixed, as part of the parameters that can't be modified in this scenario. (Note that BSS channel allocation can be evaluated in simulation scenarios where there is not a planned network (ESS), as in the residential one.) In such environments, the “traffic condition” described in the usage model document mentions:

i. Interference between APs belonging to the same managed ESS due to high density deployment: this OBSS (Overlapping Basic Service Set) interference is captured in this scenario (note that this OBSS interference is touching STAs in high SNR conditions (close to their serving APs, while in outdoor large BSS scenarios, the OBSS interference will be touching STAs in low SNR conditions (for from their serving APs));

iii. Interference with unmanaged networks (P2P links): this OBSS interference is captured in this scenario by the definition of interfering networks, defined here as random unmanaged short-range P2P links, representative of Soft APs and tethering;

iv. Interference with unmanaged stand-alone APs: this OBSS interference is currently not captured in this scenario, but in the hierarchical indoor/outdoor scenario; and

v. Interference between APs belonging to different managed ESS due to the presence of multiple operators: this OBSS interference is currently not captured in this scenario, but in the outdoor large BSS scenario.

Other important real-world conditions representative of such environments are also captured in this scenario that include existence of unassociated clients, with regular probe request broadcasts.

In order to focus this scenario on the issues related to high density, the channel model is considered as a large indoor model (TGn F).

Some details of key evaluation parameters for scenario 3 are:

| Evaluation Parameter | Value |
|---|---|
| Layout | Indoor Small BSSs Scenario 3 (Reuse |
| | 3) |
| Inter-Cell-Distance | 30 meters |
| Channel Models | 2.45 Ghz, IMT-Adv* Indoor hotspot, |
| | LoS channel |
| Max Tx Power | 15 dBm/15 dBm for AP/STA |
| Tx/Rx Antenna | 1 as initial setting |
| STA Distribution | 10 STAs per BSS with uniform |
| | distribution |
| Bandwidth | 20 Mhz channel; |
| Scheduling | CCA based channel access |

*International Mobile Telecommunications-Advanced

The simulation result for the exemplary techniques herein are summarized in the following table:

| | STA DL | STA UL | D2D |
|---|---|---|---|
| | Mean (Mpbs) | Mean(Mpbs) | Mean(Mpbs) |
| DSC | 0.4151 | 0.2051 | 4.3848 |
| (one selected result) | | | |
| New Method (with | 0.5628 | 0.4226 | 20.9227 |
| alternative #3) | | | |
| Gain (%) | 35.6% | 106.1% | 377.2% |

DL = Downlink
UL = Uplink

The results clearly show that the new proposed methodology not only achieves a significant gain for the station connected through the access point, but also provides for more gain for the D2D stations due to the interference control techniques disclosed herein.

In accordance with one exemplary aspect of the techniques for the new CCA methodology, the CCA level for each STA is defined as a uniformed equation:

CCA_{STA}=CCA_{BSS}+CCA_{offset} Eq. 1

Where:
CCA_{STA} is the CCA level calculated for each STA, expressed in dBm;
CCA_{BSS} is the base CCA level for a BSS coverage area, expressed in dBm;
   If to be broadcast, the value can be different for different BSS;
   If not to be broadcast, a default value (such as −82/−62 dBm) can be used. (It should of course be appreciated that any value can be chosen as the default value as appropriate); and
   CCA_{offset} is the dynamic CCA offset value calculated in each STA, this is used for interference mitigation, expressed in dB.

For interference control and mitigation, there are at least three possible alternative solutions for CCA_{Offset}.

A first solution for determining the CCA_{Offset} is provided as Alternative #1:

CCA_{Offset}^{dB}=max(0,RSSI_{HomeAPBeacon}^{dBm}−RSSI_{AllOtherBeacons}^{dBm}) Eq.2

A second solution for determining the CCA_{Offset} is provided as Alternative #2:

CCA_{Offset}^{dB}=max(0,RSSI_{FromCommunicationPartner}^{dBm}−RSSI_{AllOtherStationsandAPs}^{dBm}) Eq. 3

A third solution for determining the CCA_{Offset} is provided as Alternative #3:

CCA_{Offset}^{dB}=max(0,RSSI_{FromCommunicationPartner}^{dBm}−RSSI_{OneMaximumOtherDevice}^{dBm}) Eq. 4

### Where:

RSSI_{HomeAPBeacon}^{dBm} is the RSSI (received signal strength indicator) measured value for a home BSS AP's beacon signal (or other reference signal(s)),
RSSI_{AllOtherBeacons}^{dBm} is the RSSI accumulated value for all other BSS APs' beacon signals (or other reference signal(s)),
RSSi_{FromCommunicationPartner}^{dBm} is the RSSI measured value for the device communication partner's reference signal,
RSSI_{AllOtherStationsandAPs}^{dBm} is the RSSI accumulated value for all other BSS devices' reference signals, and
RSSI_{OneMaximumOtherDevice}^{dBm} is the maximum RSSI value of all other BSS devices' reference signals.

The theory behind setting CCA_{Offset} is as follows. For a station (STA), if there is strong interference from another BSS, then the CCA_{Offset} will be small and the station will avoid strong interference by utilizing a less aggressive scheduling strategy. On the other hand, if the interference from all other BSSs is small, then the CCA_{Offset} will be large, and the station can be programmed to be more aggressive on spatial reuse to tolerate the interference.

For the interference from a STA in the same BSS, the energy level is typically large and around the scale of RSSI_{FromCommunicationPartner}^{dBm}. However, the technique disclosed herein uses CCA_{offset} to ensure that the CCA level used by the station is smaller than RSSI_{FromCommunicationPartner}^{dBm}. Therefore, strong interference from the same BSS can be avoided.

Alternatives #1, #2, and #3 can be selected for different usage cases or deployments as appropriate.

In operation, the CCA setting procedure should be executed periodically in each station/AP, with the period set to, for example, 100 milliseconds, 1 second, or in general any value of time as decided by, for example, a system configuration, implementation setting, the communication environment and/or changes in the communication environment.

FIG. 2 illustrates an exemplary transceiver, such as that found in a station or an access point adapted to implement the techniques herein. In addition to well-known componentry (which has been omitted for clarity), the transceiver 200 includes one or more antennas 204, an interleaver/deinterleaver 208, an analog front end 212, memory/storage 216, controller/microprocessor 220, interference control and mitigation module 224, transmitter 228, modulator/demodulator 232, encoder/decoder 236, MAC Circuitry 240, receiver 242, a dynamic CCA offset value determination module 246, a CCA module 250 and optionally one or more radios such as the cellular radio/Bluetooth®/Bluetooth® low energy radio 254. The various elements in the transceiver 200 are connected by one or more links 5 (not shown, again for sake of clarity). The wireless device 200 can have one more antennas 204, for use in wireless communications such as multi-input multi-output (MIMO) communications, Bluetooth®, etc. The antennas 204 can include, but are not limited to directional antennas, omnidirectional antennas, monopoles, patch antennas, loop antennas, microstrip antennas, dipoles, and any other antenna suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

In addition to well-known operational steps which will not be described, the interference control and mitigation module 224, in cooperation with the controller 220, measures received beacons, or other reference signals (such as RSSI) and caches the measurements in the memory 216 for the next step. By using these measured and stored RSSI values, the station then calculates, with the cooperation of the dynamic CCA offset value determination module 246, controller 220, and memory 216, CCA_{Offset}^{dB}. As discussed above, one of Alternatives 1-3 (Eqs. 2-4) are selected for the calculation of this value.

Next, the CCA value CCA_{STA} for each station is determined by using Eq. 1:

CCA_{STA}=CCA_{BSS}+CCA_{Offset}

The CCA_{BSS} can be set in accordance with one of two alternatives:

i. The CCA_{BSS} can be set as a default value (For example, −82 dBm or −62 dBm, or in general to any value as appropriate), or

ii. The CCA_{BSS} is broadcast using an AP broadcast message, for example, by including the CCA_{BSS} in beacon information.

After the CCA_{STA} is calculated, the CCA_{STA} can be cached and stored in the memory 216. The CCA_{STA} is then utilized for executing the clear channel assessment (CCA) by the CCA module 250 as discussed above, the CCA assessment being included in the distributed coordination function (DCF), which, for example, is defined in IEEE 802.11.

One exemplary advantage of the interference control based dynamic CCA scheme discussed herein is that it greatly improves overall wireless LAN system performance compared to other similar methodologies. The technique also provides an excellent mechanism for simultaneous transmission for spatial reuse and backward compatibility.

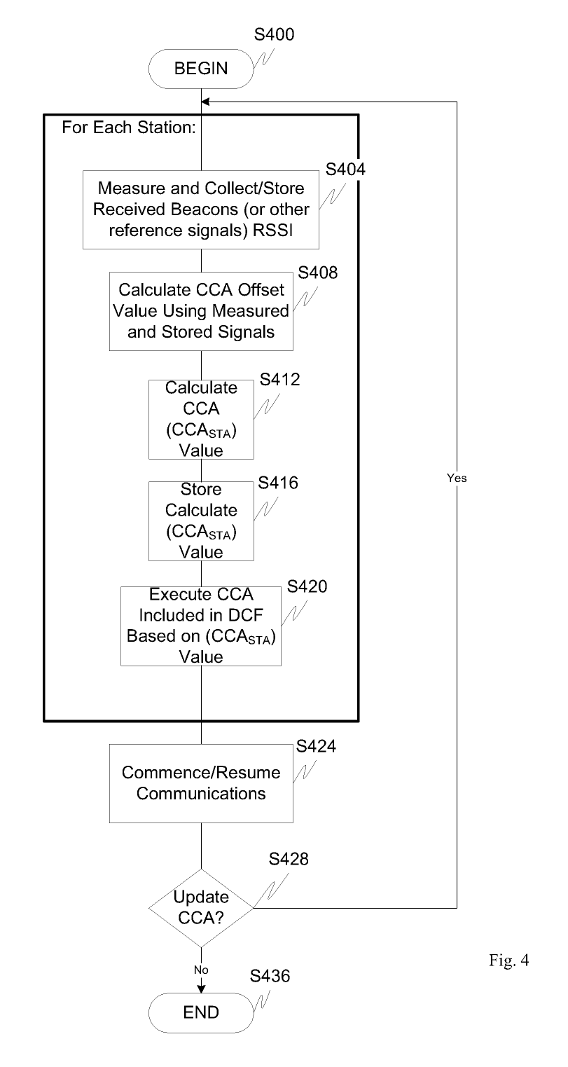

FIG. 4 outlines an exemplary methodology for performing interference control based dynamic CCA. In particular, control begins in step S400 and continues to steps S404-S420 which are performed for each station/AP.

In particular, in step S404, the received beacons, or other reference signal(s), or RSSI's are measured and stored. Next, in step S408, the CCA offset value is calculated using the measured and stored signals from step S404. Then, in step S412, the CCA value CCA_{STA} is calculated in accordance with the above equations. Control then continues to step S416.

In step S416, the calculated CCA value CCA_{STA} is stored. Then, in step S420, the calculated CCA value CCA_{STA} is used in the CCA calculations included in the distributed Coordination Function (DCF). Control then continues to step S424 where communications commence or resume with control continuing to step S428.

In step S428, a determination is made whether to update the CCA. If the CCA is to be updated, control jumps back to step S404, with control otherwise continuing to step S436 where the control sequence ends.

The exemplary embodiments are described in relation to CCA determination in a wireless transceiver. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to 802.11 transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

1. A communications device comprising:
a processor; and
a CCA (Clear Channel Assessment) value determination module adapted to use at least one measured reference signal to determine a CCA level for at least one station of a plurality of stations, the determined CCA level usable for executing a clear channel assessment.

2. The device of aspect 1, further comprising an interference control and mitigation module adapted to measure the at least one reference signal.

3. The device of aspect 1, further comprising a clear channel assessment module adapted to execute the clear channel assessment.

4. The device of aspect 1, wherein the CCA level is to be determined for each station of the plurality of stations in a communication environment.

5. The device of aspect 1, wherein the CCA level is based on a CCA level for a BBS (Basic Service Set) coverage area and a dynamic CCA offset value.

6. The device of aspect 5, wherein the dynamic CCA offset value is based on a received signal strength indicator for a home access point beacon and a received signal strength indicator for all other beacons.

7. The device of aspect 5, wherein the dynamic CCA offset value is based on a received signal strength indicator from a communication partner and a received signal strength indicator for all other stations and access points.

8. The device of aspect 5, wherein the dynamic CCA offset value is based on a received signal strength indicator for a communication partner and a maximum received signal strength indicator for all other BSS devices' reference signals.

9. The device of aspect 5, wherein the dynamic CCA offset value is to be determined to ensure that the CCA level is less than the received signal strength indicator from a communication partner.

10. The device of aspect 1, further comprising: one or more radios connected to one or more antennas, and a storage device or circuit.

11. A method comprising:

using at least one measured reference signal to determine, by a processor in a transceiver, a CCA level for at least one station of a plurality of stations; and

executing a clear channel assessment based on the determined CCA level.

12. The method of aspect 11, further comprising measuring the at least one reference signal.

13. The method of aspect 11, further comprising executing the clear channel assessment.

14. The method of aspect 11, wherein the CCA level is determined for each station of the plurality of stations in a communication environment.

15. The method of aspect 11, wherein the CCA level is based on a CCA level for a BBS (Basic Service Set) coverage area and a dynamic CCA offset value.

16. The method of aspect 15, wherein the dynamic CCA offset value is based on a received signal strength indicator for a home access point beacon and a received signal strength indicator for all other beacons.

17. The method of aspect 15, wherein the dynamic CCA offset value is based on a received signal strength indicator from a communication partner and a received signal strength indicator for all other stations and access points.

18. The method of aspect 15, wherein the dynamic CCA offset value is based on a received signal strength indicator for a communication partner and a maximum received signal strength indicator for all other BSS devices' reference signals.

19. The method of aspect 15, wherein the dynamic CCA offset value is determined to ensure that the CCA level is less than the received signal strength indicator from a communication partner.

20. A system comprising:

a memory; and

one or more processors including Medium Access Control (MAC) circuitry comprising a CCA (Clear Channel Assessment) value determination module to use at least one measured reference signal to determine a CCA level for at least one station of a plurality of stations, the determined CCA level usable for executing a clear channel assessment.

21. The system of aspect 20, further comprising an interference control and mitigation module adapted to measure the at least one reference signal, and one or more of: a Bluetooth radio, a cellular radio and one or more antennas.

22. The system of aspect 20, further comprising a clear channel assessment module adapted to execute the clear channel assessment.

23. The system of aspect 20, wherein the CCA level is to be determined for each station of the plurality of stations in a communication environment.

24. The system of aspect 20, wherein the CCA level is based on a CCA level for a BBS (Basic Service Set) coverage area and a dynamic CCA offset value.

25. The system of aspect 24, wherein the dynamic CCA offset value is based on:

a received signal strength indicator for a home access point beacon and a received signal strength indicator for all other beacons,

a received signal strength indicator from a communication partner and a received signal strength indicator for all other stations and access points, or

a received signal strength indicator for a communication partner and a maximum received signal strength indicator for all other BSS devices' reference signals.

26. A non-transitory computer-readable information storage media having stored thereon computer-implemented instructions for performing a method comprising:

using at least one measured reference signal to determine, by a processor in a transceiver, a CCA level for at least one station of a plurality of stations; and

executing a clear channel assessment based on the determined CCA level.

27. The media of aspect 26, further comprising measuring the at least one reference signal.

28. The media of aspect 26, further comprising executing the clear channel assessment.

29. The media of aspect 26, wherein the CCA level is determined for each station of the plurality of stations in a communication environment.

30. The media of aspect 26, wherein the CCA level is based on a CCA level for a BBS (Basic Service Set) coverage area and a dynamic CCA offset value.

31. The media of aspect 30, wherein the dynamic CCA offset value is based on a received signal strength indicator for a home access point beacon and a received signal strength indicator for all other beacons.

32. The media of aspect 30, wherein the dynamic CCA offset value is based on a received signal strength indicator from a communication partner and a received signal strength indicator for all other stations and access points.

33. The media of aspect 30, wherein the dynamic CCA offset value is based on a received signal strength indicator for a communication partner and a maximum received signal strength indicator for all other BSS devices' reference signals.

34. The media of aspect 30, wherein the dynamic CCA offset value is determined to ensure that the CCA level is less than the received signal strength indicator from a communication partner.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s) 5, connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an 802.11 transceiver, or the like. Examples of wireless protocols that can be used with this technology include 802.11a, 802.11b, 802.11g, 802.11n, 802.11ac, 802.11ad, 802.11af, 802.11ah, 802.11ai, 802.11aj, 802.11aq, 802.11ax, WiFi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented on one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can be used to implement the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM1926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium, executed on programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has been provided systems and methods for dynamic CCA determination. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A communications device comprising:
a processor; and
a CCA (Clear Channel Assessment) value determination module adapted to use at least one measured reference signal to determine a CCA level for at least one station of a plurality of stations, the determined CCA level usable for executing a clear channel assessment.

2. The device of claim 1, further comprising an interference control and mitigation module adapted to measure the at least one reference signal.

3. The device of claim 1, further comprising a clear channel assessment module adapted to execute the clear channel assessment.

4. The device of claim 1, wherein the CCA level is to be determined for each station of the plurality of stations in a communication environment.

5. The device of claim 1, wherein the CCA level is based on a CCA level for a BBS (Basic Service Set) coverage area and a dynamic CCA offset value.

6. The device of claim 5, wherein the dynamic CCA offset value is based on a received signal strength indicator for a home access point beacon and a received signal strength indicator for all other beacons.

7. The device of claim 5, wherein the dynamic CCA offset value is based on a received signal strength indicator from a communication partner and a received signal strength indicator for all other stations and access points.

8. The device of claim 5, wherein the dynamic CCA offset value is based on a received signal strength indicator for a communication partner and a maximum received signal strength indicator for all other BSS devices' reference signals.

9. The device of claim 5, wherein the dynamic CCA offset value is to be determined to ensure that the CCA level is less than the received signal strength indicator from a communication partner.

10. The device of claim 1, further comprising: one or more radios connected to one or more antennas, and a storage device or circuit.

11. A method comprising:
using at least one measured reference signal to determine, by a processor in a transceiver, a CCA level for at least one station of a plurality of stations; and
executing a clear channel assessment based on the determined CCA level.

12. The method of claim 11, further comprising measuring the at least one reference signal.

13. The method of claim 11, further comprising executing the clear channel assessment.

14. The method of claim 11, wherein the CCA level is determined for each station of the plurality of stations in a communication environment.

15. The method of claim 11, wherein the CCA level is based on a CCA level for a BBS (Basic Service Set) coverage area and a dynamic CCA offset value.

16. The method of claim 15, wherein the dynamic CCA offset value is based on a received signal strength indicator for a home access point beacon and a received signal strength indicator for all other beacons.

17. The method of claim 15, wherein the dynamic CCA offset value is based on a received signal strength indicator from a communication partner and a received signal strength indicator for all other stations and access points.

18. The method of claim 15, wherein the dynamic CCA offset value is based on a received signal strength indicator for a communication partner and a maximum received signal strength indicator for all other BSS devices' reference signals.

19. The method of claim 15, wherein the dynamic CCA offset value is determined to ensure that the CCA level is less than the received signal strength indicator from a communication partner.

20. A system comprising:
a memory; and
one or more processors including Medium Access Control (MAC) circuitry comprising a CCA (Clear Channel Assessment) value determination module to use at least one measured reference signal to determine a CCA level for at least one station of a plurality of stations, the determined CCA level usable for executing a clear channel assessment.

21. The system of claim 20, further comprising an interference control and mitigation module adapted to measure the at least one reference signal, and one or more of: a Bluetooth radio, a cellular radio and one or more antennas.

22. The system of claim 20, further comprising a clear channel assessment module adapted to execute the clear channel assessment.

23. The system of claim 20, wherein the CCA level is to be determined for each station of the plurality of stations in a communication environment.

24. The system of claim 20, wherein the CCA level is based on a CCA level for a BBS (Basic Service Set) coverage area and a dynamic CCA offset value.

25. The system of claim 24, wherein the dynamic CCA offset value is based on:
a received signal strength indicator for a home access point beacon and a received signal strength indicator for all other beacons,
a received signal strength indicator from a communication partner and a received signal strength indicator for all other stations and access points, or
a received signal strength indicator for a communication partner and a maximum received signal strength indicator for all other BSS devices' reference signals.
